(19) United States
(12) Patent Application Publication
(10) Pub. No.: US 2008/0022375 A1
(43) Pub. Date: Jan. 24, 2008

(54) Method and apparatus for using a cell phone to facilitate user authentication

(76) Inventor: David J. Stanley, Cupertino, CA (US)

Correspondence Address: INTUIT, INC.;c/o PARK, VAUGHAN & FLEMING LLP, 2820 FIFTH STREET, DAVIS, CA, 95618-7759, US

(21) Appl. No.: 11/450,599

(22) Filed: Jun. 9, 2006

(51) Int. Cl. H04L 9/32

(52) U.S. Cl. 726/5

(57) ABSTRACT

One embodiment of the present invention provides a system that communicates through a cell phone to facilitate authentication of a user of a computer system. During operation, the system receives an identifier for a user which is entered into a computer system. The system uses this identifier to lookup a cell phone number for the user, and also generates a challenge-code to for the user. The system then uses the cell phone number to communicate the challenge-code to the user through the cell phone, thereby enabling the user to enter the challenge-code into the computer system. Next, the system receives the challenge-code entered into the computer system. The system compares the entered challenge-code with the challenge-code communicated to the user. If they match, the system authenticates the user.

### BACKGROUND

### Related Art

The present invention relates to user-authentication techniques for computer systems.

In spite of recent technological advances in the field of computer security, the dominant form of access control for computer systems remains passwords. A password is typically required to login to a computer system, and additional passwords are often required to access specific computer-based applications.

However, passwords have a number of shortcomings. Passwords are insecure because users tend to use short and simple passwords to reduce the time required to enter the passwords and to make the passwords easy to remember. However, short and simple passwords tend to be less random and can be more easily cracked.

Passwords are also insecure because they can possibly be observed as they are entered; either visually, or through commonly available “spyware” software or “packet-sniffing” mechanisms.

Furthermore, passwords are hard to remember. Many organizations require passwords to be changed frequently, for example, every 90 days, to increase system security. These passwords are short-lived, which makes them hard to remember. Moreover, the proliferation of applications requiring passwords has led to a situation where users must remember multiple passwords for different applications. In order to keep track of these hard-to-remember passwords, users frequently write them on sticky notes attached to a computer monitor, which greatly compromises system security. Users also commonly employ the same password for all of the applications and computer systems that they access. Hence, if any one of these applications or computer systems is insecure, the secrecy of the single password can be compromised.

A number of different techniques can be used to overcome the above-described problems with passwords. One solution is to use a hardware token, such as a smart card, which is carried by a user to facilitate access control. However, these hardware tokens are typically expensive to deploy and maintain, and furthermore, users often forget to carry these hardware tokens.

### SUMMARY

One embodiment of the present invention provides a system that communicates through a cell phone to facilitate authentication of a user of a computer system. During operation, the system receives an identifier for a user which is entered into a computer system. The system uses this identifier to lookup a cell phone number for the user, and also generates a challenge-code to for the user. The system then uses the cell phone number to communicate the challenge-code to the user through the cell phone, thereby enabling the user to enter the challenge-code into the computer system. Next, the system receives the challenge-code entered into the computer system. The system compares the entered challenge-code with the challenge-code communicated to the user. If they match, the system authenticates the user.

In a variation on this embodiment, receiving the identifier entered into the computer system additionally involves receiving a password or pin number entered into the computer system. In this variation, the challenge-code is communicated to the user only if the password or pin number entered into the computer system is valid.

In a variation on this embodiment, communicating the challenge-code to the user involves sending the user: a text message which contains the challenge-code; a voice message which contains the challenge-code; or a graphical image which contains the challenge-code.

In a variation on this embodiment, obtaining the challenge-code for the user involves randomly generating a one-time challenge-code. This one-time challenge-code is remembered until the user is authenticated, at which time the one-time challenge-code is forgotten.

In a variation on this embodiment, obtaining the challenge-code for the user involves looking up a predetermined challenge-code for the user.

In a variation on this embodiment, using the cell phone number to communicate the challenge-code to the user involves communicating with a third-party service over computer network, wherein the third-party service communicates with the cell phone over a cell phone network.

In a variation on this embodiment, the computer system is a mobile computing device, which includes the cell phone.

### BRIEF DESCRIPTION OF THE FIGURES

FIG. 1 illustrates a system that uses a cell phone to facilitate an authentication process in accordance with an embodiment of the present invention.

FIG. 2 presents a flow chart illustrating a process which uses a cell phone to authenticate a user in accordance with an embodiment of the present invention.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not limited to the embodiments shown, but is to be accorded the widest scope consistent with the claims.

The data structures and code described in this detailed description are typically stored on a computer-readable storage medium, which may be any device or medium that can store code and/or data for use by a computer system. This includes, but is not limited to, magnetic and optical storage devices such as disk drives, magnetic tape, CDs (compact discs), DVDs (digital versatile discs or digital video discs), or any device capable of storing data usable by a computer system.

### System

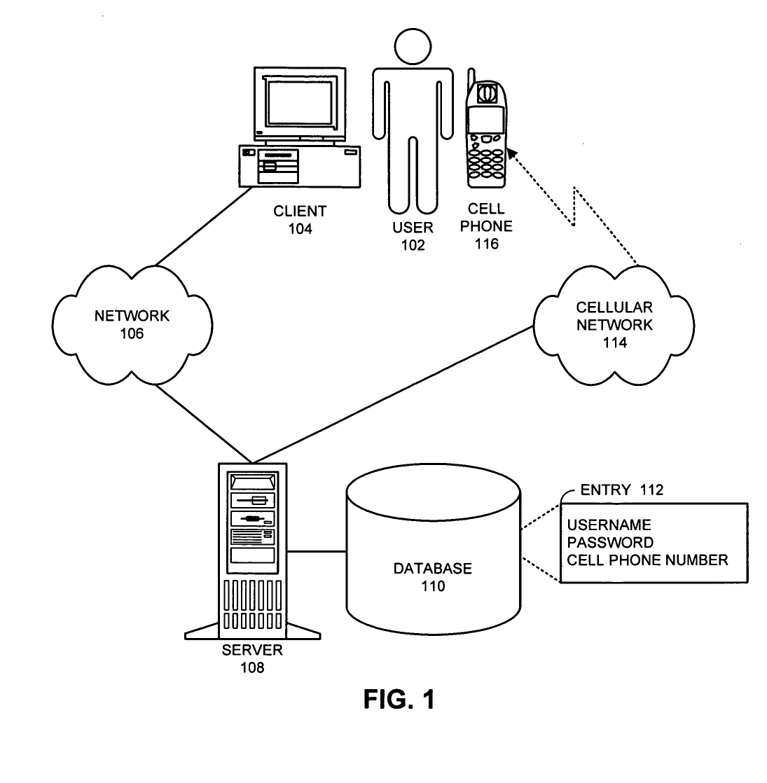

FIG. 1 illustrates a system that uses a cell phone to facilitate an authentication process in accordance with an embodiment of the present invention. The illustrated system includes a client 104, which is coupled to a server 108 through a network 106. Client 104 can generally include any node on a network including computational capability and including a mechanism for communicating across the network. Server 108 can generally include any computational node including a mechanism for servicing requests from a client for computational and/or data storage resources. Network 106 can generally include any type of wired or wireless communication channel capable of coupling together computing nodes. This includes, but is not limited to, a local area network, a wide area network, or a combination of networks. In one embodiment of the present invention, network 106 includes the Internet.

Server 108 is coupled to (or includes) a database 110. Database 110 contains a number of entries for users, and these entries can be accessed based on a user identifier, such as a username or an email address. For example, entry 112, which is associated with a user, can possibly contain a number of data items associated with the user, including: (1) a username, (2) a password and (3) a cell phone number.

Server 108 also includes some type of mechanism that uses a cell phone number to communicate with a cell phone 116 through a cellular network 114. For example, server 108 can be directly coupled to a telephone line through which it can call cell phone 116.

Alternatively, server 108 can use a network-based service to communicate with cell phone 116. For example, server 108 can send an email message which includes the cell phone number and a message to a special service (not illustrated) on network 106, and the special service can use the cell phone number to forward the message as a text message across a cellular network 114 to cell phone 116.

In another embodiment of the present invention, client 104 and server 108 are located within the same machine (or within the same application) and do not communicate with each other over a network.

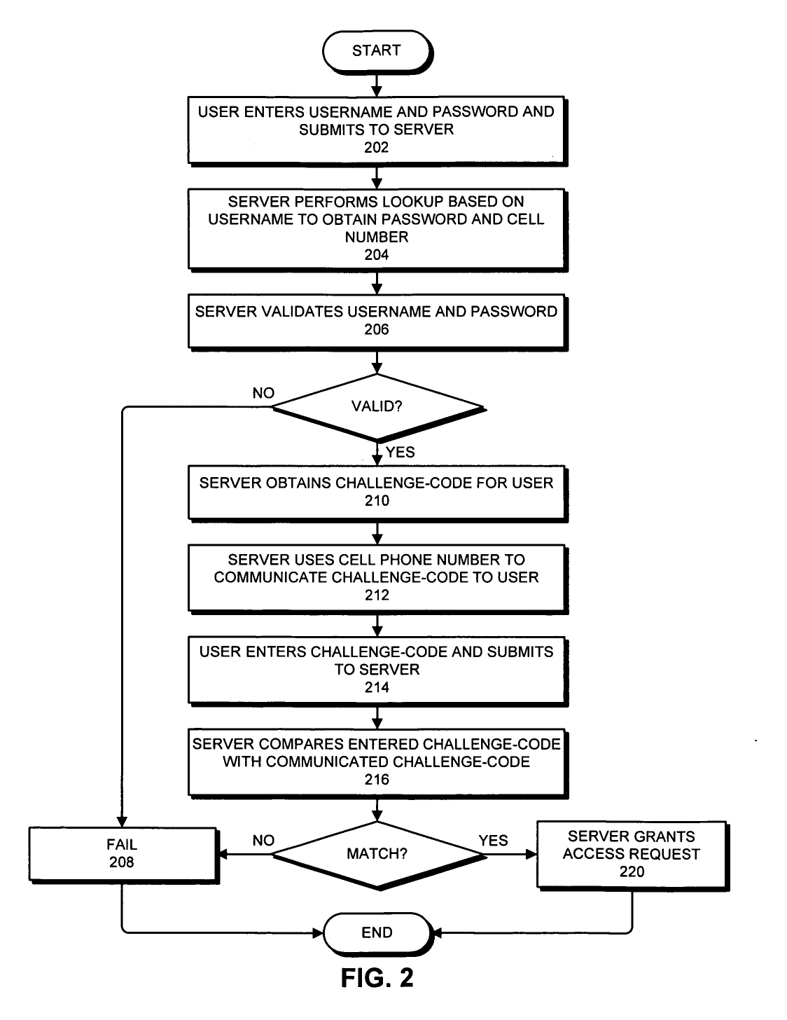

During operation of the system illustrated in FIG. 1, server 108 authenticates user 102 by communicating a “challenge-code” to user 102 through cell phone, and then waiting for user 102 to enter this challenge-code into a form on client 104. This process is described in more detail below with reference to FIG. 2.

### Authentication Process

FIG. 2 presents a flow chart illustrating a process which uses a cell phone to authenticate a user in accordance with an embodiment of the present invention. During this process, a user 102, who wants access to an application or a computer system, generates an access request by entering a username and a password into a form on client 104. When user 102 activates a submit button on the form, client 104 forwards this identifier to server 108 (step 202).

Next, server 108 uses the username to lookup an entry containing a cell phone number and a password in database 110 (step 204). Server 108 then validates the password received from user 102 against the password stored in the entry (step 206). If the password received from user 102 does not match the stored password, and is hence invalid, the access request fails (step 208).

Otherwise, if the password received from user 102 matches the stored password, and is hence valid, server 108 obtains a challenge-code for the user (step 210). This can involve randomly generating a one-time challenge-code, or alternatively, looking up a predetermined challenge-code for the user.

Next, server 108 uses the cell phone number to communicate the challenge-code to user 102 through cellular network 114 and cell phone 116 (step 212). For example, this can involve sending user 102: a text message which contains the challenge-code; a voice message which contains the challenge-code; or a graphical image which contains the challenge-code.

Next, user 102 enters the challenge-code into a form on client 104 and communicates this challenge-code to server 108. When user 102 activates a submit button on the form, client 104 forwards this identifier to server 108 (step 214).

Server 108 then compares the entered challenge-code with the challenge-code server 108 sent through cell phone 116 (step 216). If the challenge-code received by server 108 does not match the challenge-code sent through cell phone 116, the access request fails (step 208).

Otherwise, if the challenge-code received by server 108 matches the challenge-code sent through cell phone 116, server 108 grants the access request (step 220).

Note that by using a separate channel (i.e., the cell phone) to communicate the challenge-code to user 102, the system largely avoids the packet-sniffing problem, because an adversary would have to somehow: (1) monitor both the telephone network and the computer network; (2) correlate the access request with the challenge-code.

The foregoing descriptions of embodiments of the present invention have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

What is claimed is:

1. A method for communicating through a cell phone to facilitate authentication of a user of a computer system, comprising:
receiving an identifier entered into the computer system;
using the identifier to lookup a cell phone number for the user;
obtaining a challenge-code to for the user;
using the cell phone number to communicate the challenge-code to the user through the cell phone, thereby enabling the user to enter the challenge-code into the computer system;
receiving a challenge-code entered into the computer system;
comparing the challenge-code entered into the computer system with the challenge-code communicated to the user;
authenticating the user if the challenge-code entered into the computer system matches the challenge-code communicated to the user through the cell phone.

2. The method of claim 1,
wherein receiving the identifier entered into the computer system additionally involves receiving a password or pin number entered into the computer system; and
wherein the challenge-code is communicated to the user only if the password or pin number entered into the computer system is valid for the user.

3. The method of claim 1, wherein communicating the challenge-code to the user involves sending the user:
a text message which contains the challenge-code;
a voice message which contains the challenge-code; or
a graphical image which contains the challenge-code.

4. The method of claim 1, wherein obtaining the challenge-code for the user involves randomly generating a one-time challenge-code.

5. The method of claim 4, wherein the one-time challenge-code is remembered until the user is authenticated, at which time the one-time challenge-code is forgotten.

6. The method of claim 1, wherein obtaining the challenge-code for the user involves looking up a predetermined challenge-code for the user.

7. The method of claim 1, wherein using the cell phone number to communicate the challenge-code to the user involves communicating with a third-party service over computer network, wherein the third-party service communicates with the cell phone over a cell phone network.

8. The method of claim 1, wherein the computer system is a mobile computing device, which includes the cell phone.

9. A computer-readable storage medium storing instructions that when executed by a computer cause the computer to perform a method for communicating through a cell phone to facilitate authentication of a user of a computer system, the method comprising:
receiving an identifier entered into the computer system;
using the identifier to lookup a cell phone number for the user;
obtaining a challenge-code to for the user;
using the cell phone number to communicate the challenge-code to the user through the cell phone, thereby enabling the user to enter the challenge-code into the computer system;
receiving a challenge-code entered into the computer system;
comparing the challenge-code entered into the computer system with the challenge-code communicated to the user;
authenticating the user if the challenge-code entered into the computer system matches the challenge-code communicated to the user through the cell phone.

10. The computer-readable storage medium of claim 9,
wherein receiving the identifier entered into the computer system additionally involves receiving a password or pin number entered into the computer system; and
wherein the challenge-code is communicated to the user only if the password or pin number entered into the computer system is valid for the user.

11. The computer-readable storage medium of claim 9, wherein
communicating the challenge-code to the user involves sending the user:
a text message which contains the challenge-code;
a voice message which contains the challenge-code; or
a graphical image which contains the challenge-code.

12. The computer-readable storage medium of claim 9, wherein obtaining the challenge-code for the user involves randomly generating a one-time challenge-code.

13. The computer-readable storage medium of claim 12, wherein the one-time challenge-code is remembered until the user is authenticated, at which time the one-time challenge-code is forgotten.

14. The computer-readable storage medium of claim 9, wherein obtaining the challenge-code for the user involves looking up a predetermined challenge-code for the user.

15. The computer-readable storage medium of claim 9, wherein using the cell phone number to communicate the challenge-code to the user involves communicating with a third-party service over computer network, wherein the third-party service communicates with the cell phone over a cell phone network.

16. The computer-readable storage medium of claim 9, wherein the computer system is a mobile computing device, which includes the cell phone.

17. An apparatus for communicating through a cell phone to facilitate authentication of a user of a computer system, comprising:
a receiving mechanism configured to receive an identifier entered into the computer system;
a lookup mechanism configured to use the identifier to lookup a cell phone number for the user;
an authentication mechanism configured to,
obtain a challenge-code to for the user,
use the cell phone number to communicate the challenge-code to the user through the cell phone, thereby enabling the user to enter the challenge-code into the computer system,
receive a challenge-code entered into the computer system,
compare the challenge-code entered into the computer system with the challenge-code communicated to the user, and to
authenticate the user if the challenge-code entered into the computer system matches the challenge-code communicated to the user through the cell phone.

18. The apparatus of claim 17,
wherein the receiving mechanism is additionally configured to receive a password or pin number entered into the computer system; and
wherein the authentication mechanism is configured to communicate the challenge-code to the user only if the password or pin number entered into the computer system is valid for the user.

19. The apparatus of claim 17, wherein the authentication mechanism is configured to communicate the challenge-code to the user by sending the user:
a text message which contains the challenge-code;
a voice message which contains the challenge-code; or
a graphical image which contains the challenge-code.

20. The apparatus of claim 17, wherein the authentication mechanism is configured to obtain the challenge-code for the user by randomly generating a one-time challenge-code.

21. The apparatus of claim 20, wherein the one-time challenge-code is remembered until the user is authenticated, at which time the one-time challenge-code is forgotten.

22. The apparatus of claim 17, wherein the authentication mechanism is configured to obtain the challenge-code for the user by looking up a predetermined challenge-code for the user.

23. The apparatus of claim 17, wherein while communicating the challenge-code, the authentication mechanism is configured to communicate with a third-party service over computer network, wherein the third-party service communicates with the cell phone over a cell phone network.

24. The apparatus of claim 17, wherein the computer system is a mobile computing device, which includes the cell phone.
